(19) United States
(12) Patent Application Publication
(10) Pub. No.: US 2011/0071925 A1
(43) Pub. Date: Mar. 24, 2011

(54) SYSTEM AND METHOD OF PROVIDING A BROWSE TREE FOR AD LISTINGS

(75) Inventor: Trevor Robert Milton, St. George, UT (US)

(73) Assignee: LEXON INDUSTRIES INC., Carson City, NV (US)

(21) Appl. No.: 12/566,440

(22) Filed: Sep. 24, 2009

(51) Int. Cl. G06Q 30/00; G06F 3/048; G06Q 10/00

(52) U.S. Cl. 705/27.1; 715/843; 705/343; 715/853

(57) ABSTRACT

A method for facilitating the listing in an ad of items within an electronic catalog of an online ad repository, comprising a process of providing an item category tree, which contains a plurality of nodes arranged in a plurality of levels, wherein the plurality of nodes are made up of distal nodes to represent items of the catalog and non-distal nodes to represent categories of items, and presenting successive non-distal nodes for selection until a user places the ad according to item categories and subcategories that represent characteristics of the item for sale.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Disclosure

The disclosure relates to browse trees and other types of hierarchical browse structures used to help users list items to sell online according to a category or set of traits of the item. More specifically, the disclosure relates to methods for identifying and calling to the attention of users the nodes of a browse tree that are the most specific according to detail of the available characteristics.

2. Description of Related Art

With the increasing popularity of person to person sales on the internet and the World Wide web, it has become common for merchants to set up web sites for peer to peer ad listings much like newspapers of old for selling products and services. Via such a site, consumers can access and place ads from an online catalog or browse tree that includes many of possible items and item categories.

Many online merchants and other businesses group their products, services or other items into a set of categories and subcategories of a browse tree. Browse trees often do not go far enough in allowing a user to find only exactly the items they may be looking for, and the user becomes bogged down with having to look at many ads that may be not what is wanted.

Despite the advantages of known ad listing systems, improvements are still being sought and the prior art is thus characterized by several disadvantages that may be addressed by the disclosure. The disclosure minimizes, and in some aspects eliminates, the above-mentioned failures, and other problems, by utilizing the methods and system features described herein.

The features and advantages of the disclosure will be set forth in the description that follows, and in part will be apparent from the description, or may be learned by the practice of the disclosure without undue experimentation. The features and advantages of the disclosure may be realized and obtained by means of the features and combinations particularly pointed out in the appended claims.

One problem commonly encountered by online sellers is the inability to effectively present their goods and services to consumers via their browse trees with enough detail to allow for targeted exposure. Due to the large number of possible items and item categories, many “specific” categories and items remain hidden from the user or may be not contemplated at all by a prior art browse tree structure.

From an online electronics buyers (user) point of view, for example, when a potential buyer begins navigation of a typical browse tree for locating specific electronics having memory, the user initially sees a list of categories that broadly describes different electronic items. At this point, the user typically may not see more specific categories such as, for example, “memory type,” even though “memory type” may be the most specific category at that time for an item. The “memory type” category may be nested within the browse tree under electronics/computers/maker/memory type, allowing the user to navigate downward through multiple levels of the tree to find the category of most interest to the user. Similarly, the user would not see other specific electronics because they too would be nested within the browse tree under a different figurative branch. Furthermore, once the user locates the specific categories and electronic types, the user typically has no desire to be bothered by electronics ads that do not have the characteristics of interest. The ability of users to identify the specific trait categories of interest helps users to locate items that may be exactly what they may be looking for, or at least know that what they may be looking for is not available at this time from any seller. The disadvantages are also true when the user is a seller and wishes to list the item to be sold very specifically such that potential buys can readily find the item in a large ad repository.

The disclosure addresses these and other problems by providing a computer-implemented system and method for a multi dimensional browse tree or other hierarchical browsing structure, and for calling nodes of a browse tree to the attention of users during navigation of the browse structure.

### SUMMARY

The disclosure may provide a computer-implemented system and method for a multi dimensional browse tree or other hierarchical browsing structure, and for calling nodes of a browse tree to the attention of users during navigation of the browse structure. The system and method may be particularly useful for assisting users in locating specific products and/or product categories within an online catalog of an online ad list service, but may be used in connection with browse structures of differing configurations.

The node specificity levels may be predetermined and periodically based on user selection data that reflects users' attention to particular nodes. The criteria used to measure such specificity levels depend upon the nature and purpose of the browse tree. For example, in the context of a tree used to locate items sold by a merchant, the specificity of each item may be based on one or more of the following, among other, criterion: the number of times the item was searched for, the number of times the item was viewed within or outside the browse tree, the number of times the item was listed for sale, and the average length of time the item remained for sale. The specificity of each category of the same tree may be predetermined. The specific criteria used within a given system may be largely a matter of design choice, and may be varied in order to achieve a particular objective.

The specific nodes may be called to the attention of users by automatically “listing” the nodes along child-parent paths for display within the browse structure. For example, when the user selects a particular non-distal category (a category that contains subcategories) for viewing, the most specific items corresponding to the selected category may be displayed together with the immediate subcategories, allowing the user to view or directly access these items without navigating to lower levels of the browse tree. Subcategories may be listed for display in a similar manner and in succession.

The node placement levels may be determined periodically based on user selection data collected over a predetermined period or interval of time. As a result, the nodes that may be listed for display may change over time to reflect the current interests of users. In one embodiment, nodes may be selected based on collective data for item specifics, without regard to other traits that may not have been included in the browse tree.

In another embodiment, information known about the individual item may be incorporated into the selection process to select nodes that reflect ever increasing trait detail as desired by the particular user. The system may also use broader traits as a basis for selecting nodes to include in the browse tree. For example, the nodes may be scored and listed based in-whole or in-part on ad listing selection data collected for the particular period. The indicating time may include times wherein the period is predetermined, or may be reflective of times wherein the tree is being added to.

In an embodiment for use by an online item seller, the system and method may be used to generate the most specific item categories on web pages corresponding to higher-level categories. The most specific items and categories may be determined periodically based on types of user selection data. The nodes to be listed may be selected, on a node-by-node basis, by selecting the most specific nodes from the immediate branches of the current node. Items and low-level categories that may be currently very specific thus tending to be listed at deeper levels within the tree.

An embodiment may comprise a computer-implemented method for facilitating the listing in an ad of items within an electronic catalog of an online ad repository comprising: providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include a step of processing by a computer processor in said tree server at least the predetermined non-distal node data to generate node selection data from which a user may select successive non-distal nodes therefrom during navigation. Additionally, a step based at least in-part on the selected non-distal node, of automatically presenting successive non-distal nodes for selection until a user places the ad according to item categories and subcategories that represent characteristics of the item for sale and may be included.

An embodiment may comprise a computer-implemented method for facilitating the listing in an ad of items within an electronic catalog of an online ad repository comprising: providing an item category tree that contains a plurality of nodes arranged in a plurality of levels, wherein the item category tree is provided by a tree server that is electronically connected to a network of computers. The plurality of nodes may be made up of distal nodes to represent items of the catalog and non-distal nodes to represent categories of items and wherein said item category tree is navigable by users for listing items for sale according to item categories and subcategories. The embodiment may further include a step of processing by a computer processor in said tree server at least the predetermined non-distal node data to generate node selection data from which a user may select successive non-distal nodes therefrom during navigation. Additionally, the method may include a step, based at least in-part on the selected non-distal node, of automatically presenting successive non-distal nodes for selection until a user places the ad according to item categories and subcategories that represent characteristics of the item for sale. The embodiment may further comprise an expanding tree wherein selection of a successive non-distal node causes a plurality of successive nodes to appear representing additional item characteristics.

An embodiment may comprise a computer-implemented method for facilitating the listing in an ad of items within an electronic catalog of an online ad repository comprising: providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include processing by a computer processor in said tree server at least the predetermined non-distal node data to generate node selection data from which a user may select successive non-distal nodes therefrom during navigation. Additionally, the embodiment may include a step, based at least in-part on the selected non-distal node, of automatically presenting successive non-distal nodes for selection until a user places the ad according to item categories and subcategories that represent characteristics of the item for sale may be included. The embodiment may further comprise presenting successive non-distal nodes for selection comprises a drop down type selector to wherein selection of a successive non-distal node therein causes a successive drop down type selector to appear representing additional item characteristics.

An embodiment may comprise a computer-implemented method for facilitating the listing in an ad of items within an electronic catalog of an online ad repository comprising:

providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include processing by a computer processor in said tree server at least the predetermined non-distal node data to generate node selection data from which a user may select successive non-distal nodes therefrom during navigation. Additionally, the embodiment may include a step, based at least in-part on the selected non-distal node, of automatically presenting successive non-distal nodes for selection until a user places the ad according to item categories and subcategories that represent characteristics of the item for sale may be included. The embodiment may further comprise that the successive non-distal nodes may be further categorized into item characteristic groups.

An embodiment may comprise a computer-implemented method for facilitating the listing in an ad of items within an electronic catalog of an online ad repository comprising: providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include a step of processing by a computer processor in said tree server at least the predetermined non-distal node data to generate node selection data from which a user may select successive non-distal nodes therefrom during navigation. Additionally, the embodiment may include a step, based at least in-part on the selected non-distal node, of automatically representing successive non-distal nodes for selection until a user places the ad according to item categories and subcategories that represent characteristics of the item for sale may be included. The embodiment may further comprise a count of items being sold, which is displayed to a user.

An embodiment may comprise a computer-implemented method for facilitating the listing in an ad of items within an electronic catalog of an online ad repository comprising: providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include a step of processing by a computer processor in said tree server at least the predetermined non-distal node data to generate node selection data from which a user may select successive non-distal nodes therefrom during navigation. Additionally, the embodiment may include a step, based at least in-part on the selected non-distal node, of automatically representing successive non-distal nodes for selection until a user places the ad according to item categories and subcategories that represent characteristics of the item for sale may be included. The embodiment may further comprise a count of items being sold by characteristics, which is generated and displayed proximate the corresponding non-distal category.

An embodiment may comprise a computer-implemented method for facilitating the listing in an ad of items within an electronic catalog of an online ad repository comprising: providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include a step of processing by a computer processor in said tree server at least the predetermined non-distal node data to generate node selection data from which a user may select successive non-distal nodes therefrom during navigation. Additionally, a step based at least in-part on the selected non-distal node, of automatically presenting successive non-distal nodes for selection until a user places the ad according to item categories and subcategories that represent characteristics of the item for sale may be included. The embodiment may further comprise an item category tree having thirty nine primary non-distal nodes.

An embodiment may comprise a computer-implemented method for facilitating the listing in an ad of items within an electronic catalog of an online ad repository comprising: providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include a step of processing by a computer processor in said tree server at least the predetermined non-distal node data to generate node selection data from which a user may select successive non-distal nodes therefrom during navigation. Additionally, a step based at least in-part on the selected non-distal node, of automatically presenting successive non-distal nodes for selection until a user places the ad according to item categories and subcategories that represent characteristics of the item for sale may be included. The embodiment may further comprise that the item category tree has at least three successive non-distal nodes.

An embodiment may comprise a computer-implemented method for facilitating the listing in an ad of items within an electronic catalog of an online ad repository comprising: providing an item category tree, which contains a plurality of nodes arranged in a plurality of levels, wherein the item category tree is provided by a tree server that is electronically connected to a network of computers. Wherein the plurality of nodes may be made up of distal nodes to represent items of the catalog and non-distal nodes to represent categories of items and wherein said item category tree is navigable by users for listing items for sale according to item categories and subcategories. The embodiment may further include a step of processing by a computer processor in said tree server at least the predetermined non-distal node data to generate node selection data from which a user may select successive non-distal nodes therefrom during navigation. Additionally, a step based at least in-part on the selected non-distal node, of automatically presenting successive non-distal nodes for selection until a user places the ad according to item categories and subcategories that represent characteristics of the item for sale may be included. The embodiment may further comprise that the items within the item category tree change over time in response to ad listings made by users at the nodes at predetermined intervals.

An embodiment may comprise a computer-implemented method for facilitating the buying of items within an electronic catalog of an online ad repository by providing an item category tree, which contains a plurality of nodes arranged in a plurality of levels. The embodiment may also include processing by a computer processor in said tree server predetermined non-distal node data to generate node selection data from which a user may select successive non-distal nodes therefrom during navigation; and presenting successive non-distal nodes for selection until a user selects an ad according to item categories and subcategories that represent characteristics of the item for sale.

An embodiment may comprise a computer-implemented method for facilitating the buying of items within an electronic catalog of an online ad repository by providing an item category tree, which contains a plurality of nodes arranged in a plurality of levels. The embodiment may also include processing by a computer processor in said tree server predetermined non-distal node data to generate node selection data from which a user may select successive non-distal nodes therefrom during navigation; and presenting successive non-distal nodes for selection until a user selects an ad according to item categories and subcategories that represent characteristics of the item for sale. The embodiment may further comprise a process of presenting successive non-distal nodes for selection that comprises an expanding tree wherein selection of a successive non-distal node causes a plurality of successive nodes to appear representing additional item characteristics.

An embodiment may comprise a computer-implemented method for facilitating the buying of items within an electronic catalog of an online ad repository by providing an item category tree, which contains a plurality of nodes arranged in a plurality of levels. The embodiment may also include processing by a computer processor in said tree server predetermined non-distal node data to generate node selection data from which a user may select successive non-distal nodes therefrom during navigation; and presenting successive non-distal nodes for selection until a user selects an ad according to item categories and subcategories that represent characteristics of the item for sale. The embodiment may further comprise presenting successive non-distal nodes for selection comprising a drop down type selector, wherein selection of a successive non-distal node therein causes a successive drop down type selector to appear representing additional item characteristics.

### BRIEF DESCRIPTION OF THE DRAWINGS

These and other features and advantages of the disclosure will now be described with reference to the drawings of certain preferred embodiments, which are intended to illustrate and not to limit the disclosure, and in which:

FIG. 1 illustrates an example web page that includes an item category tree.

FIG. 2 illustrates an example of an item tree server.

FIG. 3 illustrates an example of a network of components for providing an item category tree.

FIG. 4 illustrates a method for generating an item category tree.

FIG. 5 further illustrates the method shown in FIG. 4.

FIG. 6 illustrates a method for generating an item category tree.

FIG. 7 further illustrates the method shown in FIG. 6.

FIG. 8 illustrates an example web page which includes an item category tree.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise.

In describing and claiming the disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

An embodiment of a system, which represents an example of the application of the disclosure, will now be described with reference to the drawings. Variations to this system, which represent other embodiments will also be described. In the disclosed system, the system is used to identify item characteristics and low-level item categories to be listed at levels of a browse tree of an online item ad.

For purposes of illustration, the embodiment will be described in the context of the browse tree for locating items within a web site of an online item seller. The details of the browse tree and of this specific implementation may be set forth in order to illustrate, and not to limit, the disclosure. The scope of the disclosure is defined only by the appended claims.

The various item characteristics of items that may be available for purchase through the item seller's web site may be arranged within various categories and subcategories of a browse tree. Users of the web site can navigate the browse tree to locate items by characteristics based on various pre-defined types and other classifications. Users can also locate items of interest using the site's search engine, recommendation services, and other types of navigational aids.

The browse tree is in the form of a that allows a child node to have multiple parent nodes. The lowest-level nodes (or “distal-nodes”) of the browse tree represent individual item characteristics, and all other nodes represent categories (including sub-categories) of items. The lowest-level categories (those with no subcategories) may be referred to herein as “distal nodes.” Each node is displayed to the user as a selectable hyperlink, although other types of user interfaces could be used.

Selection of a node causes the children of the node to be displayed. The organization of the browse tree may be specified by system administrators using tools and methods that may be well known in the art. The categories may include pre-existing categories that may be used within the industry and/or categories that may be created for purposes of implementing the disclosure. The categories may alternatively be selected or modified dynamically by system administrators based on user actions and other criteria.

Further, the categories may be selected so as to encompass a reasonably wide range of related items for sale. Each category may lead the user to another set of subcategories. In accordance with an embodiment of the disclosure, the web site system may include software and database components that may be used to collect the selections of users, and to use this selection data to automatically evaluate the specificity levels of specific item nodes and category nodes of the tree. In the embodiment, the only types of categories that may be listed may be the most distal categories, although higher level categories could be listed in other embodiments. Node specificity levels may be determined based on user selection data falling within an interval of time, so that the nodes strongly reflect the current user trends in item sales.

The data collected for the category nodes may include, for example, the number of ads placed within each category, the number of searches performed within each category, click counts, and/or other types of selection data.

In one embodiment, such data may be collected only for the distal categories, non-distal higher-level categories may not be listed for display. In another embodiment, the non-distal data may also be collected for the non-distal categories and is used generate specific item lists. The data collected for the item nodes may additionally or alternatively include other types of data such as the number of times each item was viewed or searched for.

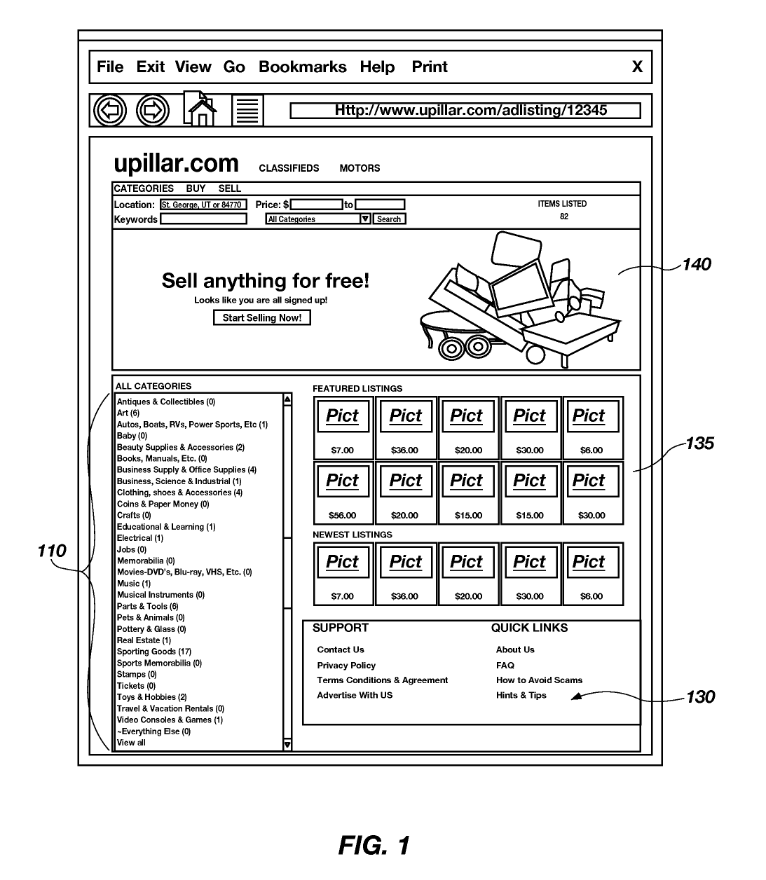

FIG. 1 illustrates an example web page that includes an example set of listed item categories 110 having listed item characteristics. As depicted by the figure, the “listed” item categories 110 having item characteristics may be derived from a branch of the browse tree which is the branch currently selected for viewing. The listed items and categories may be displayed as respective hyperlinks that provide a direct path to the corresponding items and categories. This gives the user quicker access to the most specific distal categories and items. For example, selection of a link for a listed item causes the item's detail page to be displayed, and selection of a link for a listed distal category causes the list of items falling under that category to be displayed.

The web page may also provide links 130 to the immediate subcategories of the selected item category. Although the items and categories may be listed explicitly in FIG. 1, they could alternatively be listed implicitly as regular entries on the page. For example, the listed distal categories 110 and could simply be displayed as part of the list of subcategories.

The web page may also provide featured listings 135 and advertizing space 140 for use by the administrators.

As the user moves further into the browse tree, the listed item categories and item characteristics adjust such that the most specific distal categories and item characteristics within the selected category may be displayed. The listed items may be displayed as such only at levels of the tree at which the item characteristics may not be visible, and listed categories may be displayed as such only at levels at which distal categories may be not visible. Thus, the effect is to expose to the user items within the tree, specific item characteristics and categories that would not otherwise be visible at the current level. In the embodiment, the listed nodes can be accessed by navigating downward to the fixed positions of such nodes.

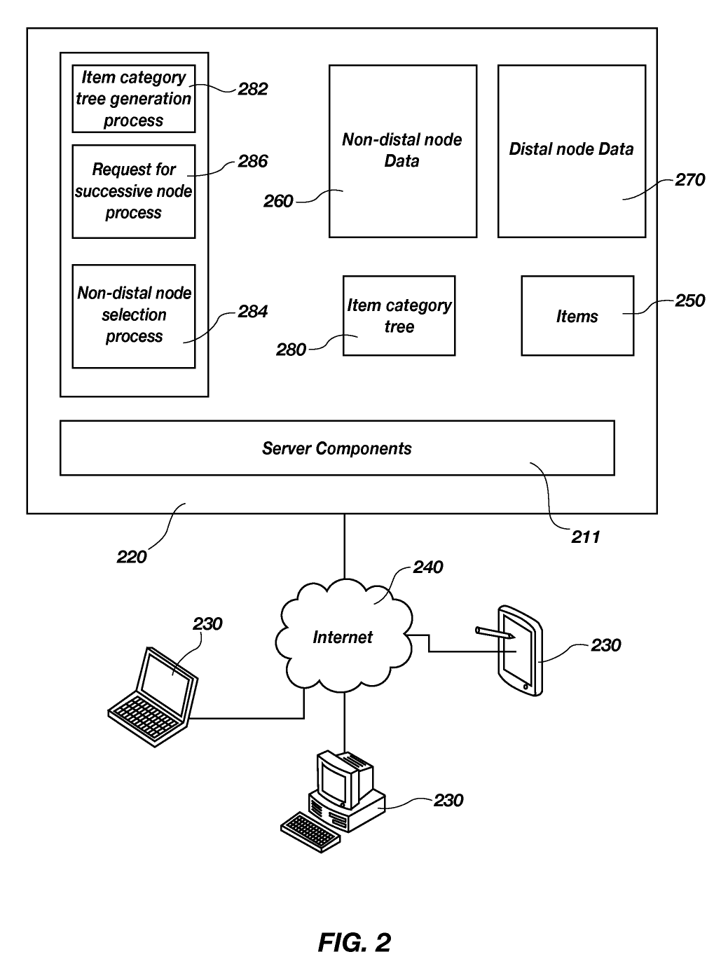

FIG. 2 illustrates a basic set of web site components based in hardware that may be used to implement an embodiment of the disclosure. As will be appreciated by those skilled in the art, the division of functionality between executable components, and the data structures used by these components, may be largely a matter of design choice and can be varied significantly without departing from the scope of the disclosure. Further, the disclosure need not be implemented in conjunction with a web site, but may be implemented as part of an online services network, or other type of information system.

The web site includes various server components 220, including a web server 211, that may be used to process requests from user computers 230 via the Internet 240. The server components 220 access a database of items 250, a item non-distal node database 260, a distal node database 270, and a category tree database 280. The non-distal node database 260 includes records for the various item characteristics. The non-distal node database 260 also includes information regarding the set of existing categories, how the categories may be related to each other, and the categories in which each item characteristic falls.

The distal node database 270 includes information about the specific items of the site. The category tree database 280 includes a tree generation process 282, a non-distal nodes selection process 284, and a Request for successive node process 286. (The term “process,” as used herein, refers generally to a computer program stored in a computer memory, and is also used to refer to the method implemented by the computer program.) The tree generation process 282 uses the item characteristics and web selection data to generate a browse tree. Other types of data structures may be used such as tables and arrays.

Specific items lists for non-distal categories may optionally be stored in a table as well. The tree generation process 282 generates these specific items lists periodically from ad listing data, and possibly other types of selection data. Each item within each specific items list is stored together with characteristic data of the item.

In an embodiment, the separate process may be omitted, and other process may be supplemented and combined with the characteristic data for some or all of the items. In this second embodiment, a common node algorithm can be used to correlate the categories and items.

The non-distal node selection process 284 uses the information stored in the data base 270 to select the successive distal categories and item characteristics to be listed in the nodes of the browse tree. In one embodiment, the distal categories and item characteristics to be displayed to a given user at each higher-level node may be determined and may be stored in a temporary table when the user initiates a browsing session or begins using the browse tree, and this temporary table is accessed when the user requests an appropriate browse tree page. Thus, the processing and storage burden associated with listing nodes is avoided for those users who do not access the site or the browse tree during the relevant time period.

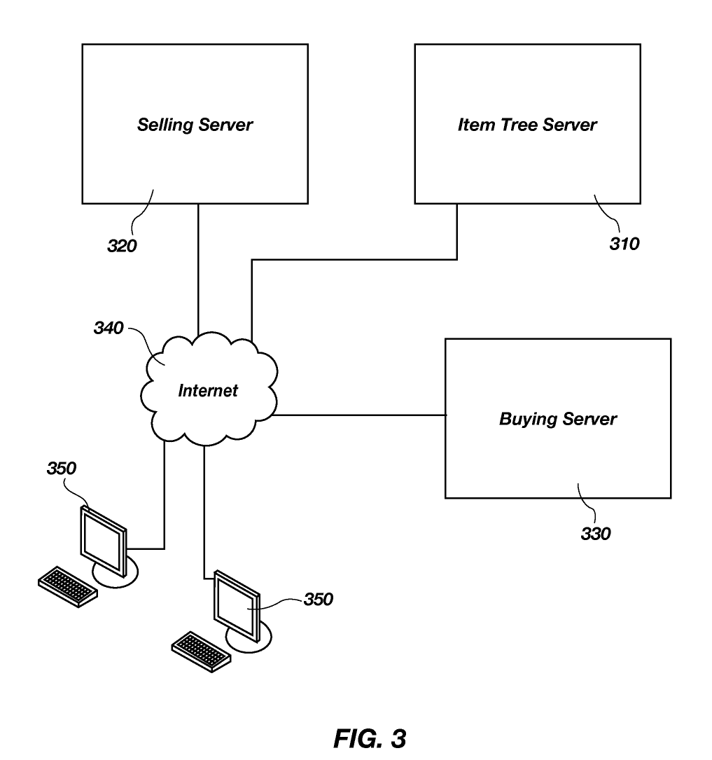

With reference now to FIG. 3 a network of components will be described that is used for placing an ad for an item. The network can also be used by a user that is a buyer looking for a specific item. In an embodiment the network may comprise an item tree server 310, a selling server 320, and a buying server 330. Each of the servers by be connected to the internet 340 through networking hardware and software. Users may communicate access the item tree server 310, the selling server 320, and the buying server 330 from a computer 350 through the internet 340, thereby forming a network. In use, a seller may place an ad for an item to sale on the selling server 320 from a computer 350. While placing the ad the user may select from a browse tree characteristics that define his item. In one embodiment a range of 10 to 45 non-distal categories may be presented to the seller. After selecting a first non-distal category, that selection data may be sent to the item tree server 310 wherein a successive browse tree is created as described above presented back to the user for a more refined selection. This process continues until a distal node is reached representing an item.

In use a buyer may search for an item to buy on a buying server 330 from a computer 350. The buyer may be presented with a browse tree of 10 to 45 non-distal nodes. After selecting a first non-distal category, that selection data may be sent to the item tree server 310 wherein a successive browse tree is created as described above and presented back to the user for a more refined selection. This process continues until a distal node is reached.

The item tree server 310, the selling server 320, and the buying server 330 may be on the same physical machine and in communication with each other. The servers may each be on a separate machine and communicate with each other over a network.

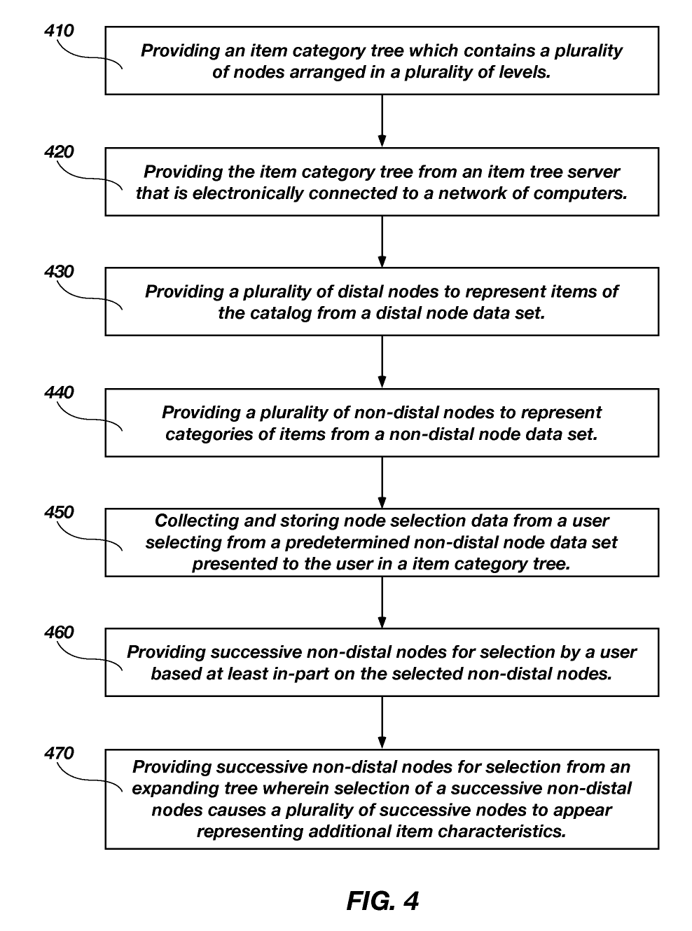

With reference to FIG. 4 an embodiment of a method will be discussed. Although the method will be discussed in a certain order other embodiments may use a differing order. In use a user at a networked computer is presented with a item category tree, which contains a plurality of nodes arranged in a plurality of levels as seen at 410. The item category tree may comprise any number of nodes and more specifically may contain 39 nodes. Each of the 39 nodes may comprise any number of levels, or non-distal nodes behind the primary nodes representing characteristics of the item.

An embodiment may contain three levels of non-distal nodes representing characteristics of the item. In an embodiment having an item tree server, it is the item tree server that provides the item category tree as seen at 420. At 430 the item tree server provides plurality of distal nodes representing items available for sale in the browse tree structure, wherein the distal nodes are stored in a distal node data set. At 440 the item tree server provides a plurality of non-distal nodes from a non-distal node data set for constructing the browse tree. At 450 the selections made by the user in the browse tree is collected and used in providing successive non-distal nodes for selection by a user. Successive non-distal nodes are the nodes representing item characteristics and are the nodes between the primary predetermined nodes and the distal nodes representing actual items. At 460 the successive non-distal nodes are provided to the user for selection. The process of 450 and the process of 460 may be repeated until a distal node is selected by the user as seen at 470.

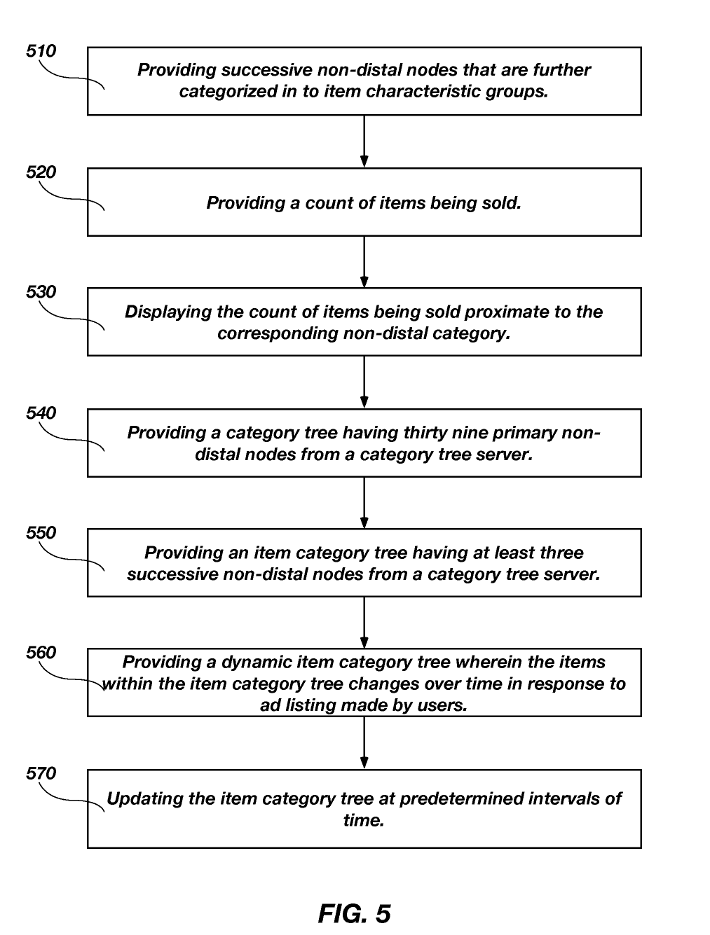

In an embodiment successive non-distal nodes may be provided representing item category groups as seen at 510 of FIG. 5. An embodiment may provide a count of items at any node within the browse tree as seen at 520. At 530 said count is displayed near or proximate to the node in the browse tree to a user, thereby allowing the user to see how many items are in each node category. At 540 an embodiment may have a predetermined primary browse tree having 39 non-distal nodes for a user to select from. At 550 an embodiment may provide at least three successive non-distal nodes from the server. An embodiment may provide a dynamic item category tree wherein the item category tree changes over time in response to ad listings made by users as seen at 560. An embodiment may provide updates at predetermined interval of time as seen at 570. It is within the scope of the disclosure to combine any of the above processes into various embodiments. It is within the scope of this disclosure to omit any of the above process in various embodiments.

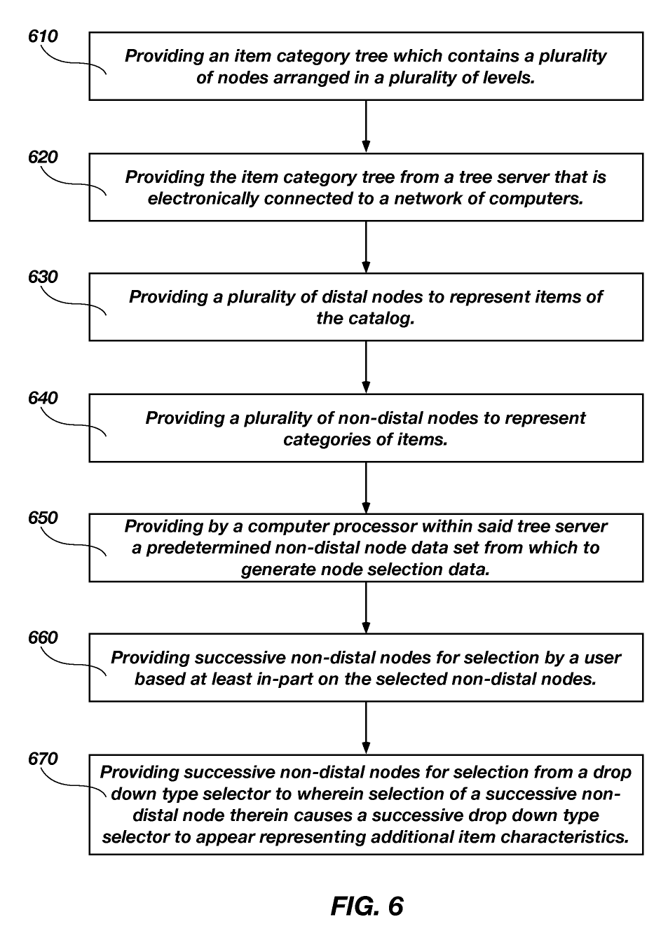

With reference to FIG. 6 an embodiment of a method will be discussed. Although the method will be discussed in a certain order other embodiments may use a differing order. In use a user at a networked computer is presented with a item category tree, which contains a plurality of nodes arranged in a plurality of levels as seen at 610. The item category tree may comprise any number of nodes and more specifically may contain 39 nodes. Each of the 39 nodes may comprise any number of levels, or non-distal nodes behind the primary nodes representing characteristics of the item.

An embodiment may contain three levels of non-distal nodes representing characteristics of the item. In an embodiment having an item tree server, it is the item tree server that provides the item category tree as seen at 620. At 630 the item tree server provides plurality of distal nodes representing items available for sale in the browse tree structure. At 640 the item tree server provides a plurality of non-distal nodes for constructing the browse tree. At 650 a predetermined non-distal node data set is provided for generating node selection data from which a user selects therefrom. Successive non-distal nodes are the nodes representing item characteristics and are the nodes between the primary predetermined nodes and the distal nodes representing actual items. At 660 the successive non-distal nodes are provided to the user for selection. The process of 650 and the process of 660 may be repeated until a distal node is selected by the user as seen at 670. As seen at 670 a drop down type selector is provided.

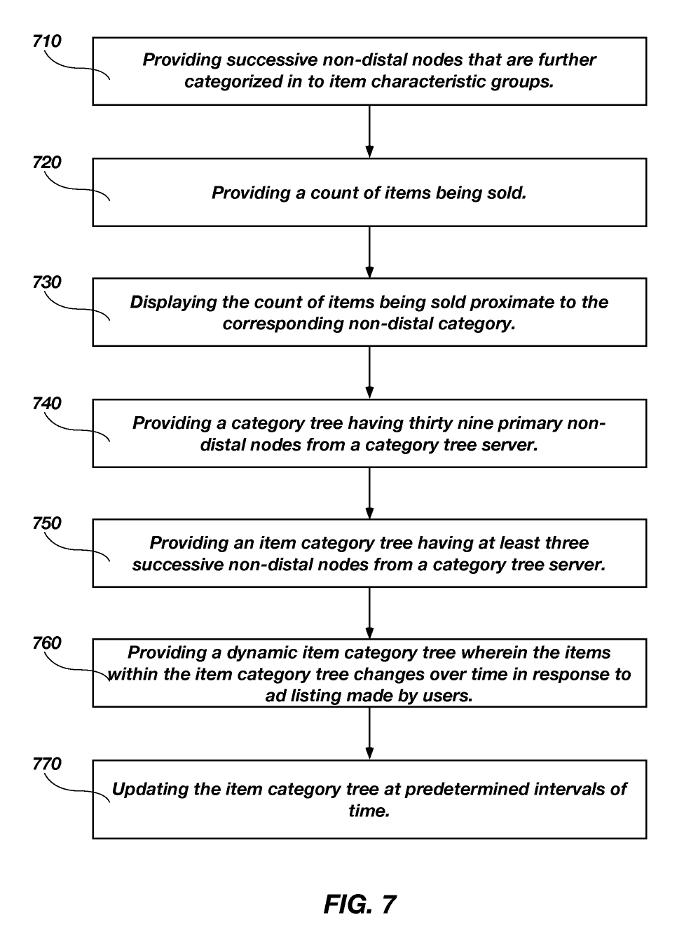

In an embodiment successive non-distal nodes may be provided representing item category groups as seen at 710 of FIG. 7. An embodiment may provide a count of items at any node within the browse tree as seen at 720. At 730 said count is displayed near or proximate to the node in the browse tree to a user, thereby allowing the user to see how many items are in each node category. At 740 an embodiment may have a predetermined primary browse tree having 39 non-distal nodes for a user to select from. At 750 an embodiment may provide at least three successive non-distal nodes from the server. An embodiment may provide a dynamic item category tree wherein the item category tree changes over time in response to ad listings made by users as seen at 760. An embodiment may provide updates at predetermined interval of time as seen at 770. It is within the scope of the disclosure to combine any of the above processes into various embodiments. It is within the scope of this disclosure to omit any of the above process in various embodiments.

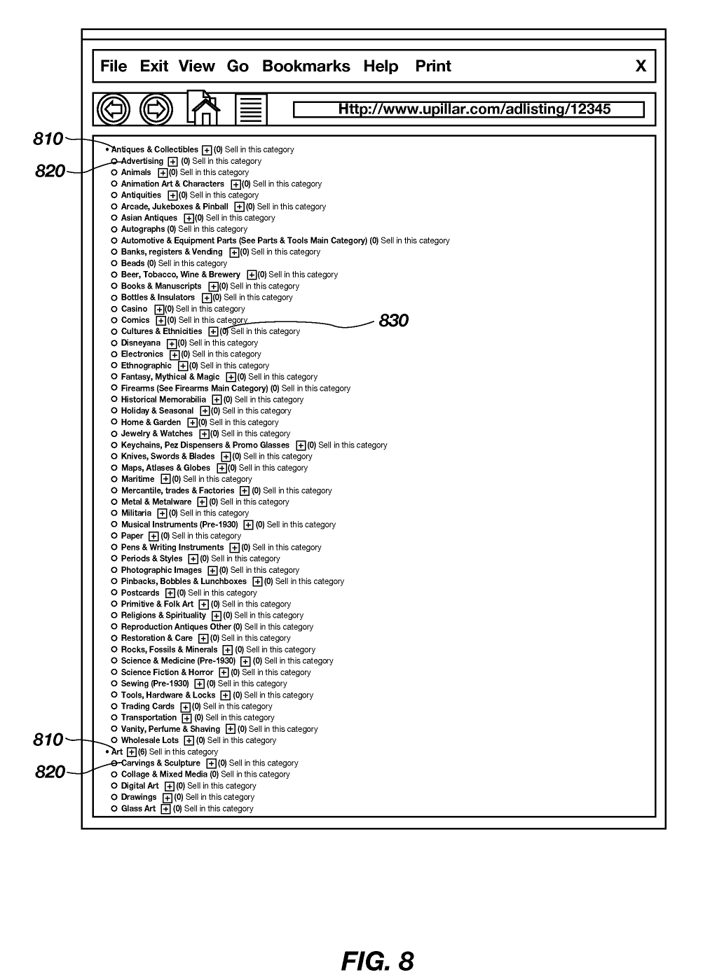

FIG. 8 illustrates an embodiment of a web page wherein non-distal nodes are shown expanded one level in a browse tree. In the embodiment a predetermined browse tree is shown having predetermined nodes. A top level predetermined node 810 is shown as antiques and collectibles. The successive nodes 820 are shown as non-distal nodes the next level down. A count 830 of the items in each node set is shown as displayed proximate to the node in a browse tree.

Although this disclosure has been described in terms of certain embodiments, other embodiments that may be apparent to those of ordinary skill in the art, including embodiments that do not provide all of the features and advantages set forth herein, may be also within the scope of this disclosure. Accordingly, the scope of the disclosure is defined only by reference to the appended claims.

In the foregoing, various features of the disclosure are grouped together for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A computer-implemented method for facilitating a listing of ads representing items for sale within an electronic catalog of an online ad repository, comprising:
providing an item category tree, which contains a plurality of nodes arranged in a plurality of levels;
wherein the item category tree is provided by a tree server that is electronically connected to a network of computers;
wherein the plurality of nodes are made up of distal nodes to represent items of the catalog and non-distal nodes to represent categories of items;
said item category tree being navigable by users to list items for sale according to item categories and subcategories;
processing by a computer processor in said tree server at least a predetermined non-distal node data to generate node selection data from which a user may select successive non-distal nodes therefrom during navigation; and
automatically presenting successive non-distal nodes for selection until a user places the ad according to item categories and subcategories that represent characteristics of the item for sale based at least in-part on the previously selected non-distal node.

2. The method of claim 1, wherein presenting successive non-distal nodes for selection comprises an expanding tree wherein selection of a successive non-distal node causes a plurality of successive nodes to appear representing additional item characteristics.

3. The method of claim 1, wherein presenting successive non-distal nodes for selection comprises a drop down type selector to wherein selection of a successive non-distal node therein causes a successive drop down type selector to appear representing additional item characteristics.

4. The method of claim 1, wherein the successive non-distal nodes may be further categorized in to item characteristic groups.

5. The method of claim 1, wherein a count of items being sold is displayed to a user.

6. The method of claim 1, wherein a count of items being sold by characteristics is generated and displayed proximate the corresponding non-distal category.

7. The method of claim 1, wherein processing at least the purchase history data comprises processing user selection data on a community-specific basis for a plurality of communities.

8. The method of claim 1, wherein the item category tree has thirty nine primary non-distal nodes.

9. The method of claim 1, wherein the item category tree has at least three successive non-distal nodes.

10. The method of claim 1, wherein the items within the item category tree change over time in response to ad listings made by users at the nodes at predetermined intervals.

11. A system for facilitating a listing of ads representing items within an electronic catalog of an online ad repository, comprising:
a selling server;
a buying server;
an item tree server wherein said item tree server comprises:
an item category tree containing a plurality of nodes arranged in a plurality of levels;
wherein the item category tree is provided that is electronically connected to a network of computers;
wherein the plurality of nodes are made up of distal nodes to represent items of the catalog and non-distal nodes to represent categories of items;
wherein said item category tree is navigable by users to list items for sale according to item categories and subcategories;
a computer processor in said item tree server that processes at least a predetermined non-distal node data to generate node selection data from which a user may select successive non-distal nodes therefrom during navigation; and
automatically presenting successive non-distal nodes for selection until a user places the ad according to item categories and subcategories that represent characteristics of the item for sale and wherein said ad is stored on said selling server based at least in-part on the selected non-distal node.

12. The system of claim 11, wherein the item category tree has thirty nine primary non-distal nodes.

13. The system of claim 11, wherein the item category tree has at least three successive non-distal nodes.

14. A computer-implemented method for facilitating the buying of items within an electronic catalog of an online ad repository, comprising:
providing an item category tree, which contains a plurality of nodes arranged in a plurality of levels;
wherein the item category tree is provided by a tree server that is electronically connected to a network of computers;
wherein the plurality of nodes are made up of distal nodes to represent items of the catalog and non-distal nodes to represent categories of items;
wherein said item category tree being navigable by users to buy items for sale according to item categories and subcategories;
processing by a computer processor in said tree server at least a predetermined non-distal node data to generate node selection data from which a user may select successive non-distal nodes therefrom during navigation; and
automatically presenting successive non-distal nodes for selection until a user selects an ad according to item categories and subcategories that represent characteristics of the item for sale based at least in-part on the selected non-distal node.

15. The method of claim 14, wherein presenting successive non-distal nodes for selection comprises an expanding tree wherein selection of a successive non-distal node causes a plurality of successive nodes to appear representing additional item characteristics.

16. The method of claim 14, wherein presenting successive non-distal nodes for selection comprises a drop down type selector to wherein selection of a successive non-distal node therein causes a successive drop down type selector to appear representing additional item characteristics.

17. The method of claim 14, wherein the successive non-distal nodes may be further categorized in to item characteristic groups.

18. The method of claim 14, wherein a count of items being sold is displayed to a user.

19. The method of claim 14, wherein a count of items being sold by characteristics is generated and displayed proximate the corresponding non-distal category.

20. The method of claim 14, wherein processing at least the purchase history data comprises processing user selection data on a community-specific basis for a plurality of communities.

21. The method of claim 14, wherein the item category tree has thirty nine primary non-distal nodes.

22. The method of claim 14, wherein the item category tree has at least three successive non-distal nodes.

23. The method of claim 14, wherein the items within the item category tree change over time in response to ad listings made by users at the nodes at predetermined intervals.
